(19) United States
(12) Patent Application Publication
(10) Pub. No.: US 2014/0008337 A1
(43) Pub. Date: Jan. 9, 2014

(54) Method for Hybrid Machining Colored Glass

(71) Applicant: SANWA TECHNOLOGIES LIMITED, Hong Kong (HK)

(72) Inventor: Wai Lam William YIM, Hong Kong (HK)

(73) Assignee: SANWA TECHNOLOGIES LIMITED

(21) Appl. No.: 13/928,416

(22) Filed: Jun. 27, 2013

(30) Foreign Application Priority Data
Jul. 9, 2012 (CN) 201210236424.9

(51) Int. Cl. B23K 26/00

(52) U.S. Cl. CPC B23K 26/0093; B23K 26/0081
USPC 219/121.66; 219/121.84

(57) ABSTRACT

The present application relates to a method for hybrid machining colored glass, includes the following steps: (1) providing a laser generator having a machining head, the colored glass is processed through the machining head by means of laser beam emitted by the laser generator. The colored glass particles melted or vaporized by the laser beam are blown away by the pressured gas through the nozzle on the machining head, so as to form a pore on the colored glass; (2) the colored glass is further processed at the pore by means of mechanical machining tools. The method for hybrid machining colored glass in the present application possesses economical, fast machining speed and high machining successful rate (or high successful machining product rate) as such beneficial characteristics.

### CROSS-REFERENCE TO RELATED APPLICATIONS

This present application claims the benefit of Chinese Patent Application No. 201210236424.9 filed on Jul. 9, 2012; the contents of which are hereby incorporated by reference.

### FIELD OF THE TECHNOLOGY

The present application relates to a method for machining a workpiece, in particular, to a method for hybrid machining colored glass.

### BACKGROUND

Glass is a relatively transparent solid material and forms a continuous networking structure during melting. It is a silicate non-metal material whose viscosity progressively increases and hardens to thereby not crystallize during the cooling process. Due to such characteristics, glass is a common material which is applied on many products and in different industries. On the optical aspect, the use of glass is normally due to its optical transparent property. However, in some applications, colored glass is necessarily used.

Glass is generally hard but brittle. Therefore, it is required take special precautions while machining glass. Glass may easily break if excessive mechanical force is applied, such as punching, percussion drilling or stamping. Local heating that introduces local thermo expansion may also create mechanical stress which may result cracks or breakage. Thus, a large amount of poor quality products will be produced during machining and materials will be wasted and machining cost will be increased.

As FIG. 1 illustrates, during the machining of glass, normally an edge of a piece of glass is being processed first. In order to achieve required geometries, the machining paths can be vertical, horizontal or arc-shaped. Therefore, the machining of a specific hole shape within the surrounding edge of the glass must apply mechanical method to open a hole. However, the speed of opening a hole cannot be fast, since the glass can be easily damaged. After opening a hole, the machining of a specific hole shape will begin from the edge. Alternatively, as FIG. 2 illustrates, a hole can be opened on the glass through another effective method, so as to allow the mechanical machining tool to enter into the hole. Afterwards, the machining of glass is performed along the predetermined machining paths using such mechanical machining tool, so as to obtain the desired glass shape.

### SUMMARY

The present application is directed to a method for hybrid machining colored glass, the method includes the following steps:

(1): providing a laser generator having a machining head, the colored glass is processed by the machining head using the laser beam emitted by the laser generator, the colored glass particles melted or vaporized by the laser beam are blown away by the pressured gas through the nozzle on the machining head, such that a pore is formed on the colored glass; and

(2): the colored glass is processed on the pore using mechanical machinery machining tools.

The wavelength of the laser generator may be 1000 nm to 1100 nm.

The laser generator may output less than 500 Hz laser pulse every second.

The method may further include: (3) polishing the processed colored glass after step (2).

The method may further include: cleansing is performed on the surface of the polished colored glass after step (3).

The mechanical machining tool in step (2) may be a milling cutter.

The milling cutter may be installed on a rotating axis.

The rotating axis may be movable along a predetermined machining path vertically, horizontally or rotationally.

The machining head and the colored glass may be stationary.

The machining head may be stationary and the colored glass may be movable at all directions.

The machining head may be stationary and the colored glass may be movable at all directions.

The colored glass may be stationary and the machining head may be movable at all directions.

The machining head and the colored glass may be movable.

### BRIEF DESCRIPTION OF THE DRAWINGS

Below is a further description of the present application with combination of the drawings and embodiments, in the drawings:

FIG. 1 is an illustrative view of an existing method for machining glass.

FIG. 2 is an illustrative view of another existing method for machining glass.

FIG. 3 is an illustrative view of laser energy distribution.

FIG. 4 is an illustrative view of laser spot melting of glass.

FIG. 5a is an illustrative view of laser drilling

FIG. 5b is an illustrative view of laser cutting.

FIG. 5c is an illustrative view of laser engraving.

FIG. 5d is an illustrative view of laser routing.

FIG. 6 is an illustrative view of energy distribution showing laser absorbed at different depths of a glass.

FIG. 7 is an illustrative view of an energy density reaching suitable laser for machining glass.

FIG. 8 is an illustrative view of a laser generator and machining head used in the laser equipment in the present application.

FIG. 9 is a process illustrative view of the use of the machining head in the laser equipment for machining colored glass.

FIG. 10 to FIG. 13 are illustrative views of the stationary and mobile relationship between the machining head and the colored glass.

FIG. 14 is a front view of using different milling cutters during mechanical machining in the present application.

FIG. 15 is an illustrative view of a mechanical machining process using a kind of milling cutter in the present application.

FIG. 16 is an illustrative view of a mechanical machining process using another kind of milling cutter in the present application.

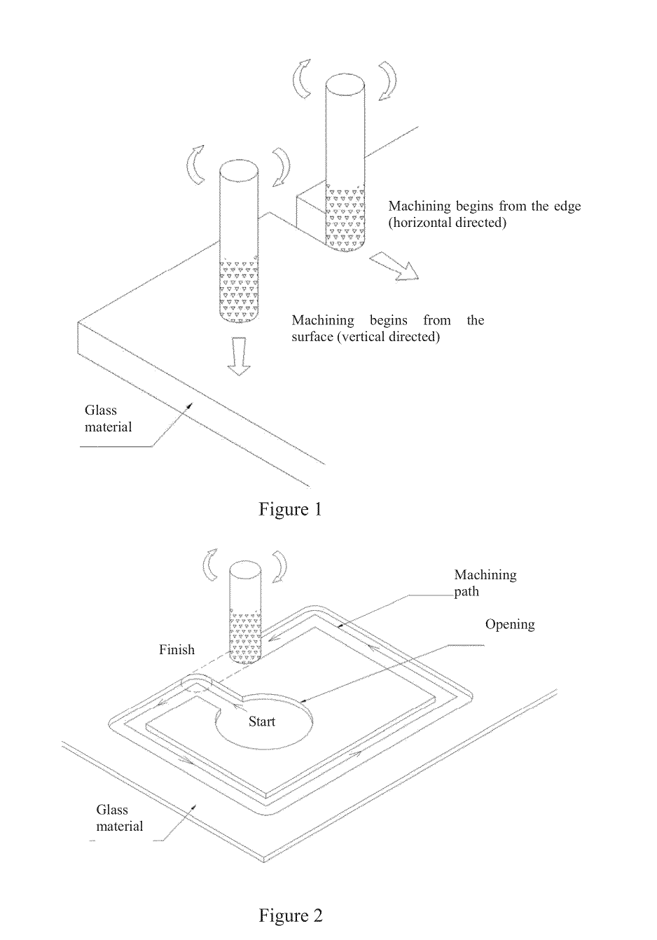

### DETAILED DESCRIPTION

In order to have a more lucid understanding on the purpose, technical solution and beneficial characteristic of the present application, below is a combination of the drawings and embodiments which further describe in detail the present application. The specific embodiments described in here merely serve for explanatory purpose towards the present application, and not for limiting the present application.

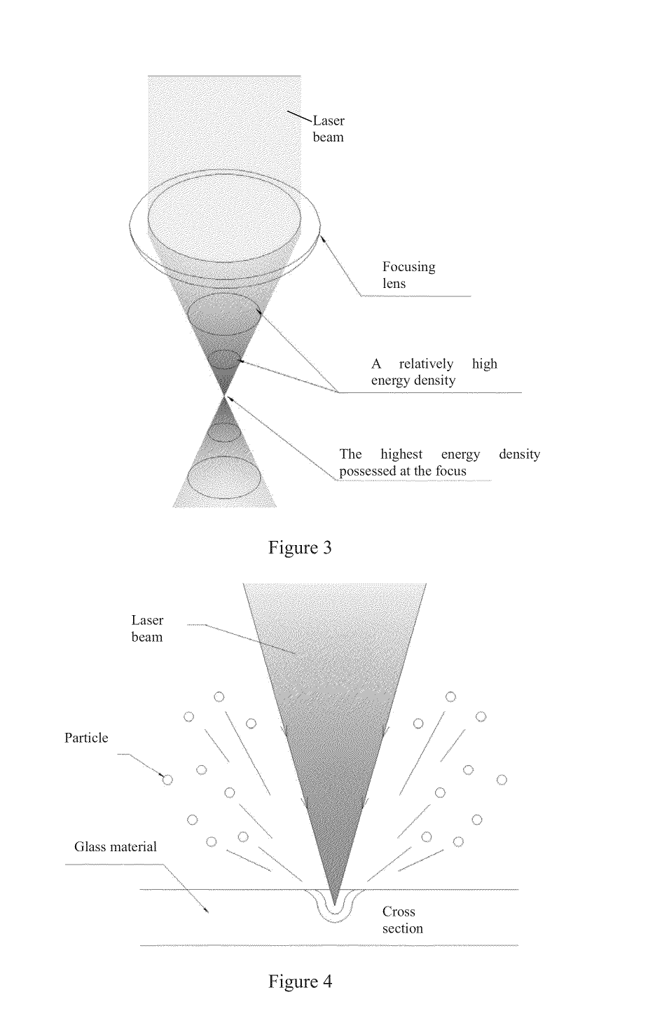

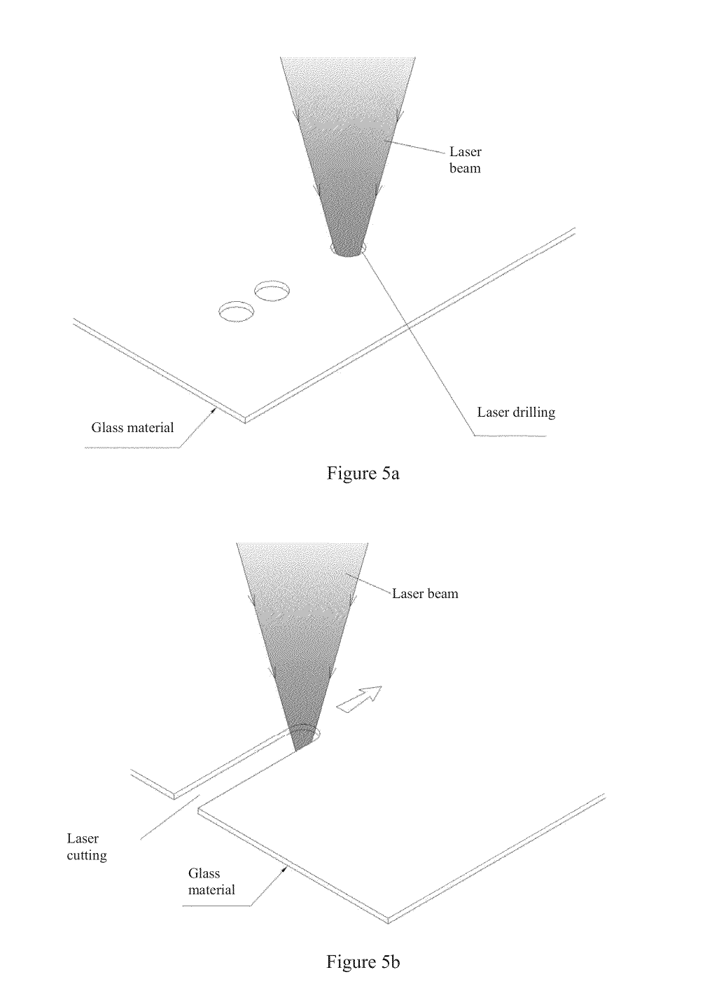

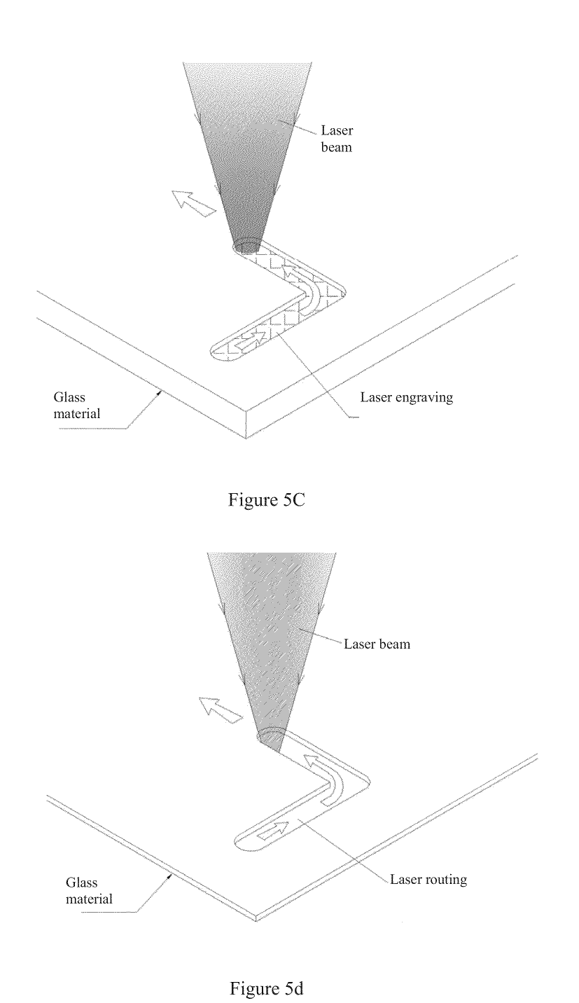

Laser is a kind of light, which produces radiation from expansion of light emitted from excitation. Due to its possessed characteristics, laser can be focused into a very small spot. Therefore, it can obtain a laser focal spot with very high energy density, such as illustrated in FIG. 3. Laser spot with high energy density can melt, vaporize or ablate a lot of materials, as illustrated in FIG. 4. Therefore, a laser device has already been widely applied in many industrial machining applications, such as laser drilling, laser cutting, laser engraving and laser routing, which are illustrated in FIGS. 5a, 5b, 5c and 5d, respectively. Common materials that can easily be processed by laser are metals and ceramics. Due to the fragility of the glass material, using laser for machining glass is not common.

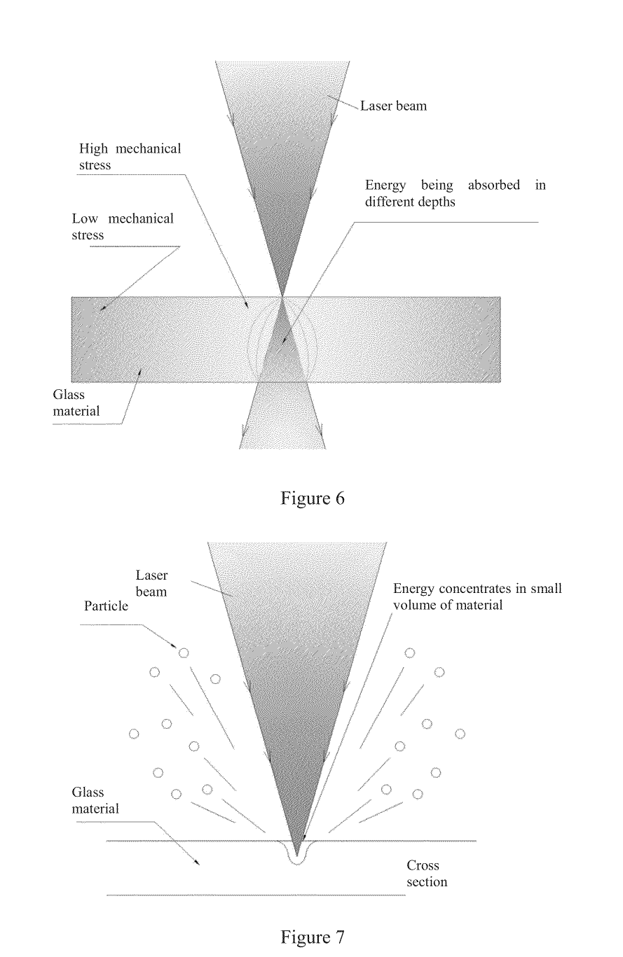

Most glasses are transparent. Since the light transmittance rate of transparent glass is high, the glass material absorbs small amount of light energy at each depth level. The laser energy being absorbed is distributed at different depths at the glass, as illustrated in FIG. 6. Therefore, the energy density is not sufficient to melt or vaporize the glass material. The energy absorbed by those glasses can only build up heat inside the glass material resulting local thermal expansion thus potentially creates cracks or breakage on the glass. Or, the glass does not absorb any energy at all, resulting nothing but keeping the glass material intact.

Glasses can be made colored by adding impurities or pigments. Depending on the types of color and the light transmittance of the glass material, the absorption of laser energy at the glass material may be different. The higher absorption at the glass material may result laser energy concentrates in smaller volume or thinner depth of material thus energy density can be reached to a level suitable for laser machining, as illustrated in FIG. 7. By increasing laser power or laser energy, glass material within the laser region may also be able to reach sufficient energy density. However, the energy dosed into or absorbed by the glass must be controlled precisely, so that the energy is high enough to allow starting of machining but not creating serious cracks or breakage on glass. The process time, energy dosed or absorbed is so critical that any excessive machining time may result a higher chance of creating cracks or breakage at glass material. Therefore, a shorter machining time is generally safer and has a higher success rate.

The present application provides a method for hybrid machining colored glass. First, the colored glass is processed through the laser beam emitted from the laser generator, producing a hole on the surface of the colored glass. Then, further machining is performed towards the hole on the surface of the colored glass through the method of mechanical milling. The method for hybrid machining colored glass in the present application possesses economical, fast machining speed and high machining successful rate (or high successful machining product rate) as such beneficial characteristics.

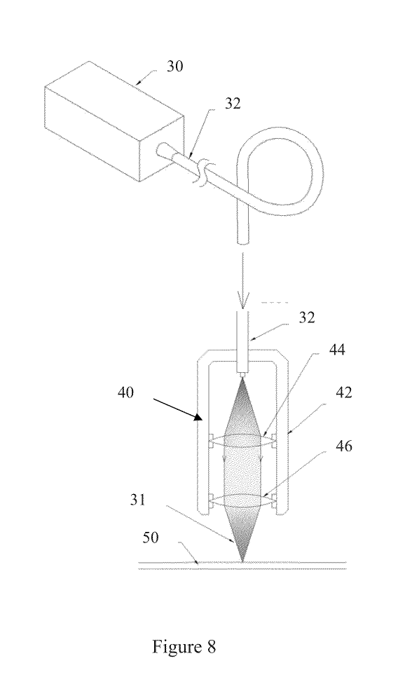

Specifically, as FIG. 8 illustrates, FIG. 8 is an illustrative view of the laser generator 30 and the processor head 40. Such laser generator 30 connects with the machining head 40 through the optical fiber 32. The laser beam 31 of such laser generator 30 travels to the machining head 40 through the optical fiber 32. The machining head 40 is used to process colored glass 50, which includes a housing 42 that connects with the optical fiber 32, a collimating lens situated inside the housing 42 used for calibrating the laser and a focus lens 46 used for focusing the laser. The focus lens 46 is located at the exterior of the collimating lens 44. The peak value of the power of the laser generator is 1000 W, and a laser pulse of less than 500 Hz is outputted every second.

Laser with low repetition rate can allow the glass to have sufficient time to absorb energy between the laser pulse so that the energy is dissipated in the colored glass. As such, the heat affected area subject to laser machining is controlled. If the laser pulse has a high repetition rate, excessive energy will accumulate inside the colored glass material which causes cracks or damage.

Furthermore, laser generator with low repetition rate can produce a relatively high laser pulse power. This can cause better melting or vaporizing so that the glass material can be removed. The wavelength of the laser generator selected is 1000 nm to 1100 nm. Due to the relatively lower cost of the laser and higher conversion efficiency of the laser energy, the power consumed would be lowered when laser power outputted is high to the furthest extent.

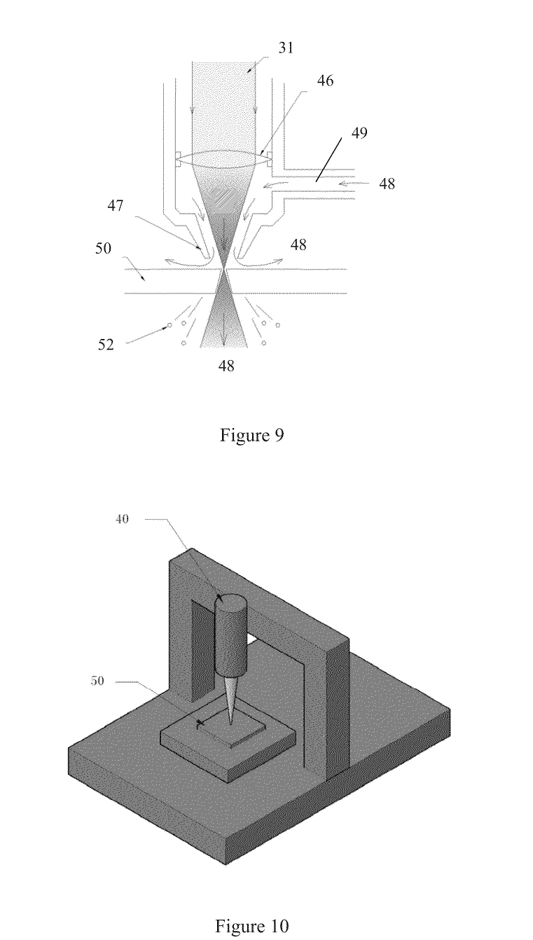

As FIG. 9 illustrates, preferably, the tip of the machining head 40 is provided with a nozzle 47, the compressed gas 48 travels to the nozzle 47 from a gas channel 49 located besides the nozzle 47 and leaks out from the nozzle 47. The compressed gas 48 can be air or other gases, such as nitrogen gas, argon gas or helium gas. The compressed gas 48 normally would be compressed at 5 bar or above. The compressed gas 48 can arrive at the surface of the colored glass material 50 with the laser spot of the laser beam 31 that are on the same axis through the nozzle 47. Since the laser spot is small, the laser energy density is sufficiently high so as to allow the colored glass material to melt or vaporize. The colored glass material at the laser spot area begins to melt or vaporize, such compressed gas (or air) 48 blows at the molten or vaporized colored glass through the nozzle so that the molten or vaporized colored glass particles 52 are removed from the laser spot area. At the same time, such compressed gas 48 (or air) cools down the colored glass and reduces the heat energy produced by the glass.

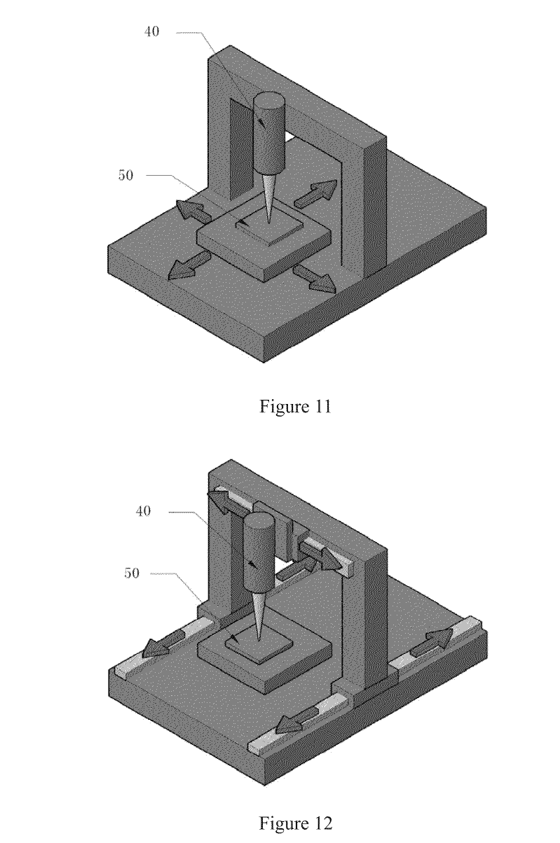

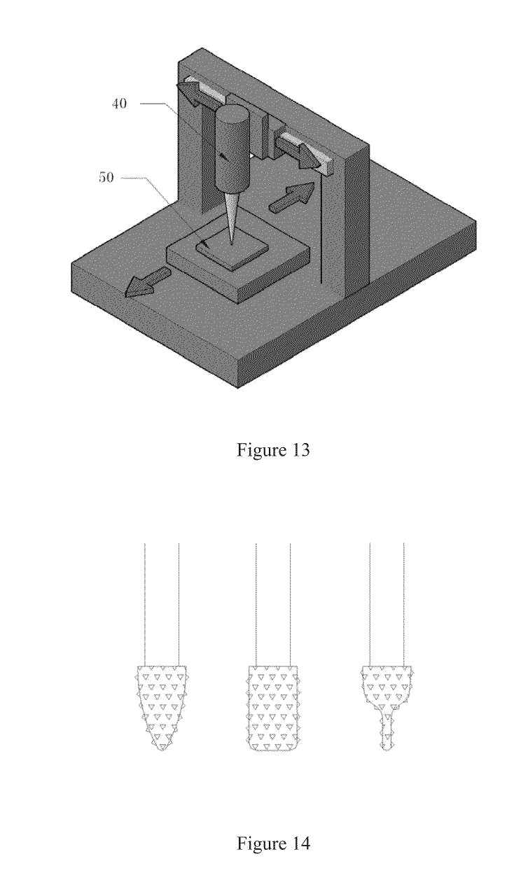

In the machining method of the present application, the machining head 40 or the colored glass 50 can be moveable or stationary, such as: the machining head 40 and the colored glass 50 can be stationary, as illustrated in FIG. 10; the machining head 40 is stationary, and the colored glass 50 can move by hand or move automatically at all directions, as illustrated in FIG. 11; the colored glass 50 is stationary, and the machining head 40 can move by hand or move automatically at all directions, as illustrated in FIG. 12; the machining head 40 and the colored glass 50 can move by hand or move automatically, or move in order or move simultaneously, as illustrated in FIG. 13. This is determined by the actual need in the machining situation.

When the machining head 40 is fixed, the fixed laser beam is used to process a relatively small hole on the colored glass material. If such machining head 40 can move, then the laser beam, which is moved by the machining head 40 operated at a specified path, can drill a relatively large hole on the colored glass material. In this craft, the laser beam can drill blind hole or open hole, which is determined by the actual need.

The size of the hole drilled through the laser should be larger than the size of the mechanical machining tool applied at the subsequent procedure, so as to allow the machining tool to enter into or pass through the hole drilled by the laser, so as to favour further machining. Since the time of laser drilling is short, the hole drilling process can be fast and at low cost. In this process, the minor cracks or deficiency produced can be removed by the subsequent mechanical machining process.

After a hole as required is formed on the surface of the colored glass material using the laser, a further machining of the hole on the glass is performed using different machining tools (different milling cutters). Please see FIG. 14 on the different milling cutters. One of the milling cutters is installed on the rotating axis, then it passes through or accesses into the above hole opened by the laser. Since the rotating speed of the rotating axis with the milling cutter is very fast, the colored glass material is removed. The rotating axis normally can vertically, horizontally or rotationally move along the predetermined machining path. The rotating axis can also move along the predetermined machining path in single or in plurality.

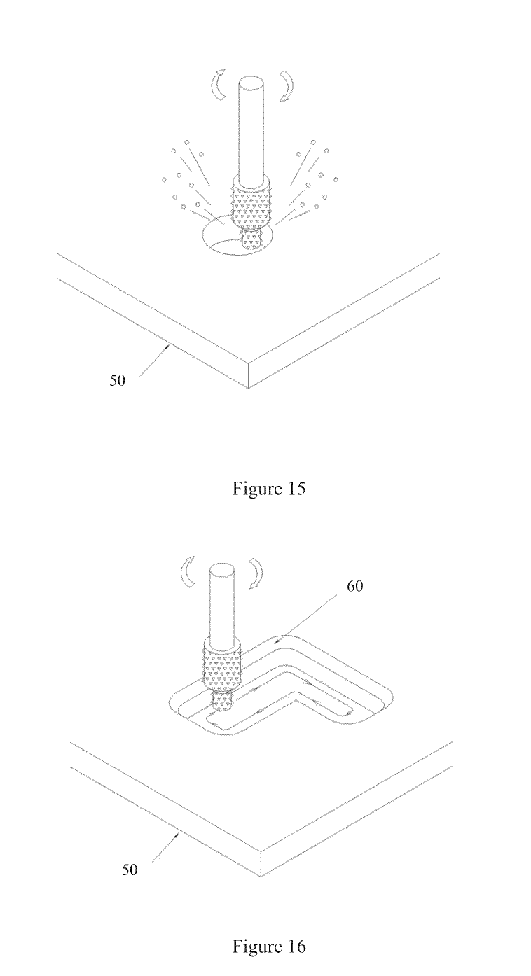

Therefore, geometric shapes in straight line, curved line, circle, chamfer 60, contour and complex geometries can be machined, as illustrated in FIGS. 15 and 16. At the same time, in the mechanical machining process, these micro cracks or imperfections can be removed.

Furthermore, in order to obtain a better smoothness and machined edge, the colored glass after machining may need to be polished. Lastly, a cleaning process may be required to remove the remaining polishing material that might have left on the surface of the colored glass. Thus, the whole process of machining of colored glass is complete.

The above is merely preferred embodiment of the present application, and is not intended to limit the present application. For all the amendments, equivalent replacements or improvements made within the spirit and principle of the present application shall fall within the protection scope of the present application.

1. A method for hybrid machining colored glass, comprising the following steps:
(1): providing a laser generator having a machining head, wherein the colored glass is processed by the machining head using the laser beam emitted by the laser generator, compressed gas passes through a nozzle on the machining head and blows away the colored glass particle being melted or vaporized by the laser beam so that a pore is formed on the colored glass; and
(2): machining the colored glass on the pore using a mechanical machinery machining tool.

2. The method for hybrid machining colored glass according to claim 1, wherein the wavelength of the laser generator is 1000 nm to 1100 nm, the laser generator outputs less than 500 Hz of laser pulse every second.

3. The method for hybrid machining colored glass according to claim 1, further comprising: (3) polishing the processed colored glass after step (2).

4. The method for hybrid machining colored glass according to claim 3, further comprising: (4) cleansing is performed on the surface of the polished colored glass after step (3).

5. The method for hybrid machining colored glass according to claim 1, wherein the mechanical machining tool in step (2) is a milling cutter.

6. The method for hybrid machining colored glass according to claim 5, the milling cutter is installed on a rotating axis.

7. The method for hybrid machining colored glass according to claim 6, the rotating axis is movable along a predetermined machining path vertically, horizontally or rotationally.

8. The method for hybrid machining colored glass according to claim 1, wherein the machining head and the colored glass are stationary.

9. The method for hybrid machining colored glass according to claim 1, wherein the machining head is stationary and the colored glass is movable at all directions.

10. The method for hybrid machining colored glass according to claim 1, wherein the colored glass is stationary and the machining head is movable at all directions.

11. The method for hybrid machining colored glass according to claim 1, wherein the machining head and the colored glass are movable.

12. The method for hybrid machining colored glass according to claim 1, wherein the machining head and the colored glass are moved in order or simultaneously.
